(19) United States
(12) Patent Application Publication
(10) Pub. No.: US 2008/0264083 A1
(43) Pub. Date: Oct. 30, 2008

(54) Gasoline-saving Vehicle A/C Controller

(76) Inventor: Huei-Fa WANG, Tainan County (TW)

Correspondence Address: Dr. BANGER SHIA;Int''l Patent Office of Bang Shia, 102 Lindencrest Ct, Sugar Land, TX, 77479-5201, US

(21) Appl. No.: 11/739,670

(22) Filed: Apr. 24, 2007

(51) Int. Cl. G05D 23/32

(52) U.S. Cl. 62/158

(57) ABSTRACT

This invention discloses a gasoline-saving vehicle A/C controller, comprising a timer with a control button and a junction. The control button of the timer is set to a pre-determined ON/OFF schedule; the junction is switched on and off by the timer in accordance with the ON/OFF schedule of the control button. The junction is connected in series to the thermo control system. When the junction is electrically activated, the vehicle A/C system of clutch relay, the compressor clutch and the compressor is correspondingly activated.

### BACKGROUND OF THE INVENTION

1. Field of the Invention

This invention relates to a gasoline-saving controller for vehicles, in particular, a gasoline-saving controller adjusting the temperature within the vehicle chamber with a timer to ease off the load on the engine by reducing the working time of an idle accelerator.

2. Related Prior Art

A conventional vehicle A/C system comprises mainly a compressor, a condenser, a storage and dehydrator for refrigerant, an expansion valve, an evaporator, a ventilator, refrigerant, and a thermo sensor. The compressor is driven by a belt, which is in turn driven by a vehicle engine, and delivers to a condenser (by high pressure) evaporated refrigerant, generated from the evaporator. The evaporated refrigerant in the condenser is then condensed into liquid. The storage and dehydrator for refrigerant is used to store, filter, and dehydrate the refrigerant. The expansion value adjusts the flow of refrigerant. The evaporator takes in heat and outputs (to the vehicle chamber) the air blown from the ventilator to the evaporator. The evaporated refrigerant is then delivered by the compressor to the condenser, forming a cycle of refrigerant.

FIG. 4 shows a conventional electrical circuit of a vehicle A/C, comprising an electrical source, a fan switch for ventilators 1, a ventilator motor 11, an A/C switch 2, a pressure switch 3, a thermo switch 4, a delay controller 5, a clutch relay 6, a compressor clutch 61, an idle accelerator 7, a cooling fan relay 8, a cooling fan relay motor 81, a fan adjuster for condensers 9, and a condenser fan motor 91. The thermo controller includes an A/C switch 2, a pressure switch 3, a thermo switch 4, and a relay controller 5. The thermo switch 4 can be adjusted to a set temperature. The ventilator motor 11 operates in accordance with the ON/OFF states of the ventilator fan switch 1. When the A/C switch 2 is turned on, an electrical current flows through the pressure switch 3 and thermo switch 4 to activate the delay controller 5; in particular, the contacts a and b are electrically activated to activate the clutch relay 6; the compressor clutch 61 is thus electrically and magnetically activated to drive the engine (not shown in FIG. 4), which in turn activates the compressor. While the contacts b and c of the delay controller 5 are electrically activated, the cooling fan relay 8 is activated to turn around the cooling fan motor 81. Furthermore, when the contacts b and d of the delay relay 5 are electrically activated, the idle accelerator 7 is activated to prevent the engine from stalling.

In general, when a vehicle driver or passenger turns on the switch for ventilators 1 and the A/C switch 2 for the desired temperature, the vehicle A/C is turned on with the operation of a compressor driven by the engine, and cold air is blown out by the ventilator; while the temperature of the output cold air can be adjusted by adjusting the volume of cold air or by other thermo controlling methods.

Nevertheless, for the above-mentioned temperature controlling techniques, it is well known that inappropriate maintenance of A/C parts may cause problems in controlling of the desired A/C temperature. Energy is fast consumed whenever a compressor is activated by an engine for some time. In addition, when a thermo sensor 4 is physically positioned around a steamer, excess cold air is produced, which takes an unnecessary load on the engine.

Some improvements made on controlling temperature within a vehicle chamber make use of a micro-computer, which nevertheless still requires a long period of operation of an A/C compressor, which in turn demands an excessive load of gasoline.

### SUMMARY OF THE INVENTION

It is therefore the purpose of the invention to provide a cost-effective compact A/C controller which is easy for assembly and demands only sufficient gasoline.

The key feature of this invention is a timer, which comes with a control button and a timer junction; the timer junction is connected to and controlled by the timer by a timer wire. The timer junction is also connected in series to the circuit of the thermo control system of the vehicle A/C system. Whereas the thermo control system comprises an A/C switch, a pressure switch, a thermo sensor switch, and a delay controller. The timer junction can be physically positioned on the circuit of the A/C switch; the timer junction acts like a conventional thermo sensor with an enhanced temperature controlling function. The timer junction operates based on the ON/OFF schedule of the thermo sensor to control the compressor via the delay controller (of the thermo control system): when the delay controller is turned on, the compressor, the fan motor for the condenser (of the vehicle A/C system), the fan motor for the cooling fan, and the idle accelerator are activated to produce only sufficient volume of cool air. When the delay controller is not electrically activated, the compressor, the fan motor of a condenser, the fan motor of a cooling fan, and the idle accelerator are not activated; nevertheless, the ventilator motor still operates to deliver repeatedly into the vehicle chamber the residual cool air remaining in the pipe or hose of the vehicle A/C conditioner, thereby easing the load on an engine and saving gasoline. The current invention also reserves to a maximal degree the original circuit of a conventional vehicle A/C system, reducing manufacture costs.

The advantages of this invention over the known art will become more apparent to those of ordinary skilled in the art upon reading the following descriptions in conjunction with the accompanying drawings.

### BRIEF DESCRIPTION OF THE DRAWINGS

FIG. 1 illustrates the structure of a preferred embodiment of the current invention;

FIG. 2 illustrates the physical position of the timer junction and the electrical circuit of a preferred embodiment of the current invention;

FIG. 3 illustrates the physical position of the timer junction in the electrical circuit of a preferred embodiment of the current invention within a vehicle A/C system;

FIG. 4 illustrates the electrical circuit of a conventional vehicle A/C system.

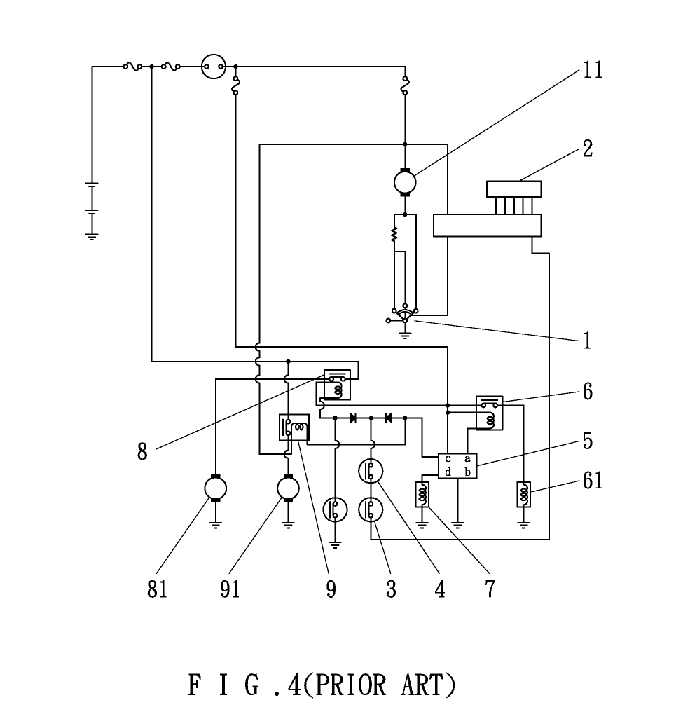

### DETAILED DESCRIPTION OF THE DRAWINGS

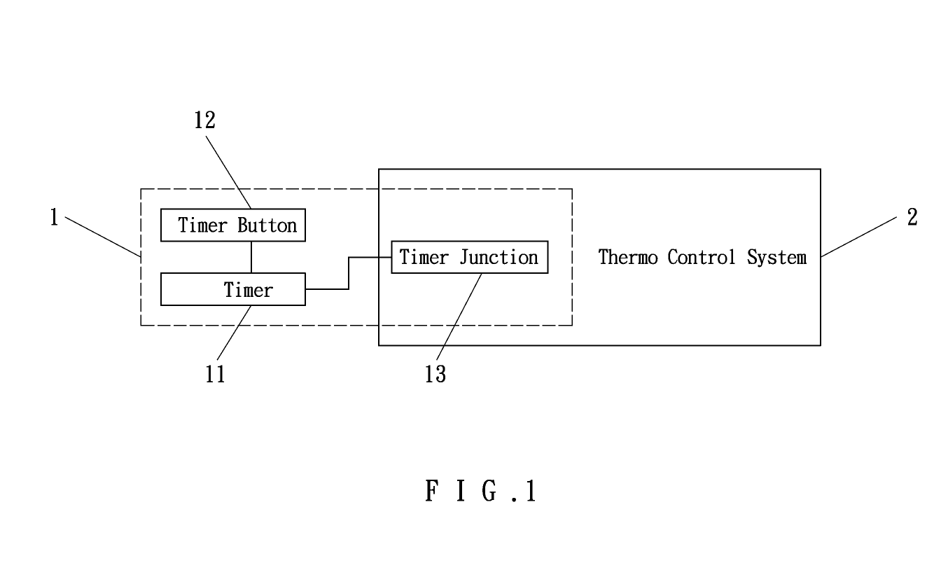

Referring to FIG. 1, the gasoline-saving A/C controller 1 of this invention comprises a timer 11, which further comprises a timer button 12 and a timer junction 13; the timer junction 13 is connected in series to the circuit of a thermo control system of a vehicle A/C system.

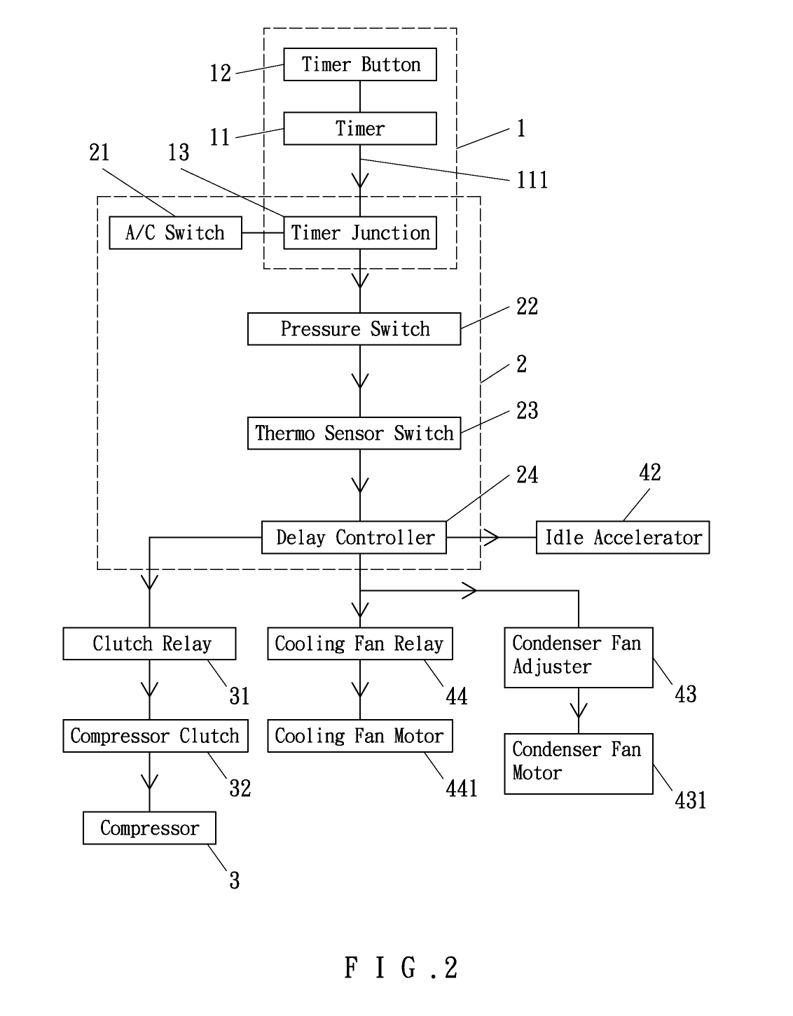

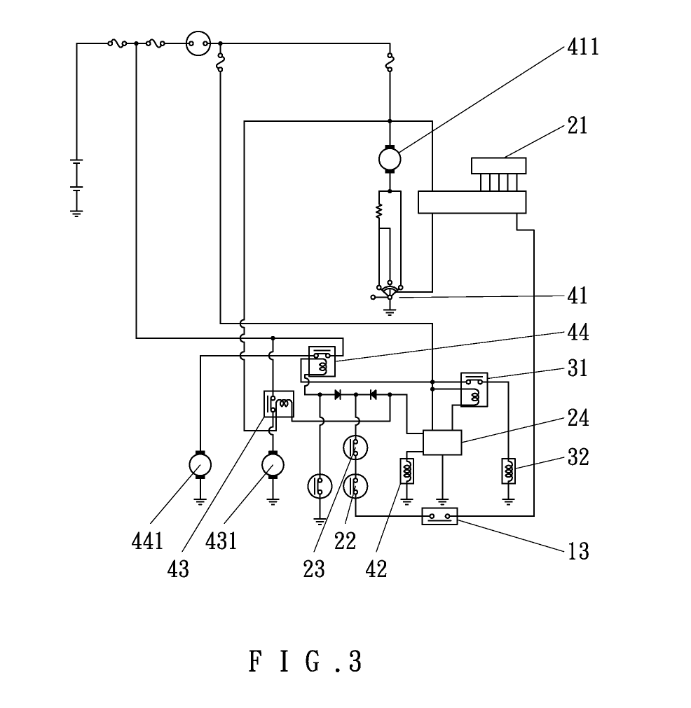

Referring further to FIG. 2 and FIG. 3, the timer junction 13 is connected to the timer 11 by a timer wire 111; the timer 11 controls the switching on and off of the timer junction 13. This invention is applicable to common or general-purpose vehicle A/C systems.

FIG. 3 illustrates the electrical circuit of a vehicle A/C system with a preferred embodiment of the present invention. The thermo control system 2 comprises an A/C switch 21, a pressure switch 22, a thermo sensor switch 23, and a delay controller 24. The timer contact is physically positioned on the circuit of the A/C switch 21. The delay controller 24 and the thermo sensor switch 23 control the clutch relay 31 and the compressor clutch 32 so that the compressor 3 is controlled by the vehicle engine (not shown in the figures).

When the compressor clutch 32 is electrically activated, the electromagnetic clutch (not shown in the figure) of the compressor 3 is magnetized, and the compressor 3 is electrically activated by the engine. When the compressor clutch 32 is not electrically activated, the electromagnetic clutch of the compressor 3 is not magnetized, and the compressor 3 is thus disabled by the engine. The electric circuit of the vehicle A/C system includes a ventilator fan switch 41, a ventilator motor 411, an idle accelerator 42, a condenser fan adjuster 43, a condenser fan motor 431, a cooling fan relay 44, and a cooling fan motor 441. Both the A/C switch 21 and the ventilator fan switch 41 are in general installed inside a vehicle chamber.

In assembly of a preferred embodiment of the present invention, the timer junction 13 of the gasoline-saving controller 1 is electrically connected in series to the wire of the A/C switch 21 (of the thermo control system 2). To achieve greater convenience in assembly, the timer junction 13 can be installed on the circuit consisting of the pressure switch 22, the thermo sensor switch 23, and the delay controller 24. The timer 11 is installed within the vehicle chamber to reserve the original wiring layout to a maximum degree. The current invention is applicable to any vehicle A/C with an equivalent thermo control system.

Referring to FIG. 1 to 3, when in use, this invention is triggered by the ventilator fan switch 41 and the A/C switch 21, in coordination with the ON/OFF schedule of the timer 110f the gasoline-saving controller 1. For instance, in summer or hot days, the timer 11 can be pre-set to ON for 10 seconds followed by an OFF for 15 seconds; while in winter or cold days, the timer can be pre-set to ON for 3 seconds followed by an OFF for 20 seconds. The pre-set schedule of the timer 11 controls the delay controller 24 for being ON and OFF. The clutch relay 31 controls the compressor clutch 32 repeatedly for being ON and OFF, and makes the compressor 3 react to the state of ON and OFF. When the timer junction 13 is electrically activated, the delay controller 24 is activated, which in turn activates the compressor 3, the condenser fan motor 431, the cooling fan motor 441, and the idle accelerator 42 to add gasoline to the engine and to produce sufficient and yet not excessive cool air.

When the junction 13 is not electrically activated, the delay controller 24 is not electrically activated and is thus turned off; the compressor 3, the condenser fan motor 431, the cooling fan motor 441, and the idle accelerator 42 are all inactivated or disabled. The idle accelerator 42 therefore stops inputting gasoline into the engine. The ventilator motor 411 still operates to deliver into the vehicle chamber residual cool air remaining in the pipe or hose of the A/C system. The timer 11 reacts to the pre-set ON/OFF schedule: during the ON section (which follows the OFF section), the timer junction 13 is again electrically activated, and the compressor 3 then functions to supply cool air. As a result, the engine consumes less time in driving the compressor 3, saving the gasoline. The gasoline-saving controller 1 also prevents from foggy windows in wet or rainy days.

Furthermore, this invention is also applicable to vehicle A/C systems equipped with constant temperature setting, which helps to reduce the time for the compressor to operate and thus saves the gasoline.

1. A gasoline-saving controller of a vehicle A/C system, comprising
a timer with a control button and
a junction installed on the circuit of said vehicle A/C system, wherein said junction is controlled by said timer for being on and off and is connected in series to the circuit of the thermo control system of said vehicle A/C system.

2. The gasoline-saving controller as claimed in 1, wherein said junction is connected to said timer by wire.

3. The gasoline-saving controller as claimed in 1, wherein said thermo control system comprises an A/C switch, a pressure switch, a thermo switch and a delay controller.

4. The gasoline-saving controller as claimed in 3, wherein said junction is installed on the circuit of the A/C switch.

5. The gasoline-saving controller as claimed in 3, wherein said junction is installed on the circuit of the pressure switch, thermo switch, and the delay controller.

6. The gasoline-saving controller as claimed in 4, wherein said junction is installed inside the engine chamber and the timer is installed inside the vehicle chamber.

7. The gasoline-saving controller as claimed in 5, wherein said junction is installed inside the engine chamber and the timer is installed inside the vehicle chamber.
